(19) United States
(12) Patent Application Publication
(10) Pub. No.: US 2025/0139979 A1
(43) Pub. Date: May 1, 2025

(54) IMPACT DETERMINATION SYSTEM, IMPACT DETERMINATION METHOD, AND RECORDING MEDIUM

(71) Applicant: NEC Corporation, Minato-ku, Tokyo (JP)

(72) Inventors: Chisato SUGAWARA, Tokyo (JP); Toshimichi YOKOTE, Tokyo (JP); Yosuke KIMURA, Tokyo (JP); Yusuke MIZUKOSHI, Tokyo (JP); Takakazu ISHII, Tokyo (JP); Hiromichi HIRATA, Tokyo (JP); Shouhei OHNO, Tokyo (JP); Nana JUMONJI, Tokyo (JP)

(73) Assignee: NEC Corporation, Minato-ku, Tokyo (JP)

(21) Appl. No.: 18/835,404

(22) PCT Filed: Feb. 28, 2022
(86) PCT No.: PCT/JP2022/008354

§ 371 Date: Aug. 2, 2024

(51) Int. Cl. G06V 20/56; G01S 13/90

(52) U.S. Cl. CPC G06V 20/56; G01S 13/9021

(57) ABSTRACT

An impact determination system according to the present invention includes: a memory configured to store instructions; and one or more processors configured to execute the instructions to: acquire a predicted surface layer state of a structure after an event, the predicted surface layer state being sensor information related to a surface of the structure on a ground surface and having been predicted based on pre-event sensor information measured before the event related to a ground of the structure; acquire post-event sensor information measured after the event; determine a post-event surface layer state of the structure based on the post-event sensor information; and determine an impact of the event on the structure based on the predicted surface layer state and the post-event surface layer state.

### BACKGROUND ART

The present invention relates to determination of an impact of an event on a structure.

### TECHNICAL FIELD

PTL 1 discloses a ground surface displacement observation device that analyzes measurements of a synthetic aperture radar before, during, and after tunnel construction to calculate a displacement of a ground surface and outputs the displacement of the ground surface. PTL 2 discloses a road shoulder collapse risk monitoring device that measures a shape of a road shoulder and a wheel position of a vehicle, calculates the strength of the road shoulder and a wheel load at the measured wheel position, calculates a collapse risk of the road shoulder at the wheel position based on the calculated strength of the road shoulder and wheel load, and notifies of the calculated collapse risk.

### CITATION LIST

### Patent Literature

PTL 1: JP 2019-132707 A
PTL 2: JP 2011-018132 A

### SUMMARY OF INVENTION

### Technical Problem

Even in a case where there is no event such as construction, a displacement, such as sinking or upheaval, occurs in the ground. A structure, such as a road, deteriorates over time. PTL 1 and PTL 2 do not disclose a technique that determines the impact of an event, such as construction, on a structure.

An object of the present invention is to provide an impact determination system and the like that more appropriately determine an impact of an event on a structure.

### Solution to Problem

According to an aspect of the present invention, there is provided an impact determination system including: a predicted state acquisition means for acquiring a predicted surface layer state of a structure after an event, the predicted surface layer state being sensor information related to a surface of the structure on a ground surface and having been predicted based on pre-event sensor information measured before the event related to a ground of the structure, a sensor information acquisition means for acquiring post-event sensor information measured after the event, a state determination means for determining a post-event surface layer state of the structure based on the post-event sensor information, and an impact determination means for determining an impact of the event on the structure based on the predicted surface layer state and the post-event surface layer state.

According to another aspect of the present invention, there is provided an impact determination method including: acquiring a predicted surface layer state of a structure after an event, the predicted surface layer state being sensor information related to a surface of the structure on a ground surface and having been predicted based on pre-event sensor information measured before the event related to a ground of the structure, acquiring post-event sensor information measured after the event, determining a post-event surface layer state of the structure based on the post-event sensor information, and determining an impact of the event on the structure based on the predicted surface layer state and the post-event surface layer state.

According to still another aspect of the present invention, there is provided a recording medium having recorded thereon a program causing a computer to execute: a process of acquiring a predicted surface layer state of a structure after an event, the predicted surface layer state being sensor information related to a surface of the structure on a ground surface and having been predicted based on pre-event sensor information measured before the event related to a ground of the structure, a process of acquiring post-event sensor information measured after the event, a process of determining a post-event surface layer state of the structure based on the post-event sensor information, and a process of determining an impact of the event on the structure based on the predicted surface layer state and the post-event surface layer state. Advantageous Effects of Invention

According to the present invention, it is possible to more appropriately determine the impact of an event on a structure.

### BRIEF DESCRIPTION OF DRAWINGS

FIG. 1 is a block diagram illustrating an example of a configuration of an impact determination system according to a first example embodiment.

FIG. 2 is a flowchart illustrating an example of an operation of the impact determination system according to the first example embodiment.

FIG. 3 is a diagram illustrating an example of a configuration of an impact determination system according to a second example embodiment.

FIG. 4 is a diagram illustrating an example of a range determined to be impacted by an event.

FIG. 5 is a diagram illustrating an example of a case where determination is executed in the entire range.

FIG. 6 is a flowchart illustrating an example of an operation of the impact determination system according to the second example embodiment.

FIG. 7 is a diagram illustrating an example of display of a surface layer state.

FIG. 8 is a diagram illustrating an example of a configuration of an impact determination system according to a third example embodiment.

FIG. 9 is a diagram illustrating determination based on a displacement.

FIG. 10 is a flowchart illustrating an example of an operation of the impact determination system according to the third example embodiment.

FIG. 11 is a diagram illustrating an example of display including a displacement.

FIG. 12 is a block diagram illustrating an example of a hardware configuration of a computer device constituting the impact determination system.

FIG. 13 is a conceptual diagram illustrating the entire system.

### EXAMPLE EMBODIMENT

Hereinafter, example embodiments of the present invention will be described with reference to the diagrams. However, example embodiments of the present invention are not limited to the description of each drawing. Example embodiments can be appropriately combined.

### First Example Embodiment

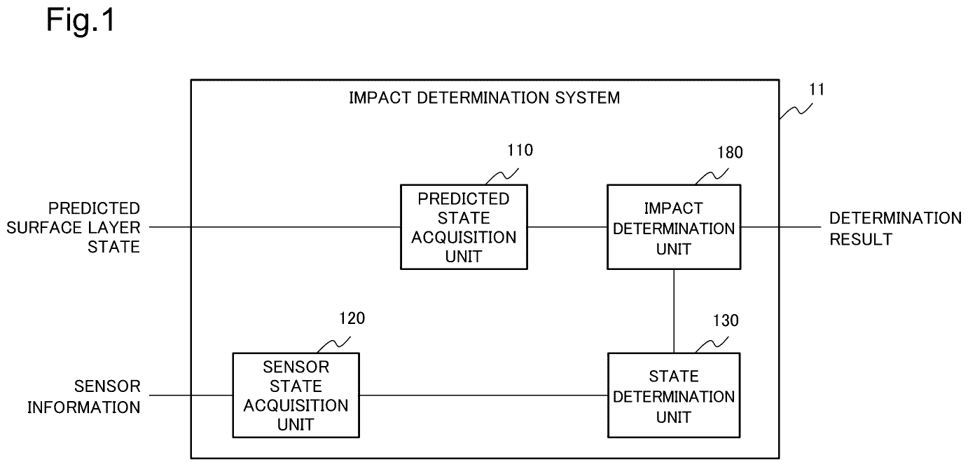

A first example embodiment of the present invention will be described with reference to the diagrams. FIG. 1 is a block diagram illustrating an example of a configuration of an impact determination system 11 according to the first example embodiment. The impact determination system 11 includes a predicted state acquisition unit 110, a sensor information acquisition unit 120, a state determination unit 130, and an impact determination unit 180.

The predicted state acquisition unit 110 acquires a predicted surface layer state of a structure on a ground surface. Hereinafter, the predicted surface layer state is referred to as a “predicted surface layer state”. The structure is, for example, a road, a bridge, a slope frame, an embankment, a pier, a revetment, or a runway. The structure may include a plurality of structures such as roads and bridges. However, the structure is not limited thereto. An event related to the ground of the structure is an event that can impact the ground of the structure. For example, the event is an underground construction of a structure such as an underground tunnel, an underground mall, an underground parking lot, a common trench, or an underground control pond. However, the event is not limited to the underground construction and may be, for example, a construction around the structure that impacts the ground of the structure, such as construction of a large building. Alternatively, the event may be a ground construction such as banking or cutting of earth. Alternatively, the event is not limited to the construction and may be, for example, an accident impacting the ground, such as rupture of a water pipe. Alternatively, the event may be a natural disaster, such as heavy rain, flood, earthquake, or extreme weather. Alternatively, the event may be a man-made disaster, such as a large scale fire or an explosion. Alternatively, the event may be a change in the usage status of infrastructures.

The predicted surface layer state acquired by the predicted state acquisition unit 110 is a surface layer state that has been predicted based on sensor information measured before the start of the event related to the ground of the structure. The predicted surface layer state is a surface layer state of the structure after the start of the event. Hereinafter, in some cases, “before the start of the event” is simply referred to as “before the event”. Hereinafter, in some cases, “after the start of the event” is simply referred to as “after the event”. That is, the term “after the event” includes during the occurrence of the event and after the event ends. The sensor information measured before the event is referred to as “pre-event sensor information”. That is, the predicted state acquisition unit 110 acquires the predicted surface layer state predicted based on the pre-event sensor information. The sensor information will be further described below.

The sensor information acquisition unit 120 acquires the sensor information measured after the event. Hereinafter, the sensor information measured after the event is referred to as “post-event sensor information”. The state determination unit 130 determines the surface layer state of the structure after the event based on the post-event sensor information. Specifically, the state determination unit 130 determines a deterioration state of the surface layer. Hereinafter, the surface layer state after the event determined based on the post-event sensor information is referred to as a “post-event surface layer state”.

The impact determination unit 180 determines the impact of the event on the structure based on the predicted surface layer state and the post-event surface layer state. A surface layer state of a structure, such as a road, changes with normal use such as passage of a vehicle. Alternatively, the structure including the surface layer changes with the lapse of time due to deterioration of a material or the like. This normal change in the surface layer state can be predicted to a certain extent from prediction based on the past surface layer state. On the other hand, in a case where the change is caused by the impact of an event, such as tunnel construction under the ground of the structure, the change is often out of the range of the prediction based on the past surface layer state. Therefore, the impact determination unit 180 determines whether the surface layer state has changed under the impact of the event based on the predicted surface layer state predicted based on the pre-event sensor information and the post-event surface layer state determined based on the post-event sensor information.

Then, the impact determination unit 180 outputs a determination result. For example, the impact determination unit 180 outputs the determination result to a display device (not illustrated) such as a terminal device including a liquid crystal display. The display device is not particularly limited as long as the display device can display the determination result.

That is, the impact determination system 11 includes the predicted state acquisition unit 110, the sensor information acquisition unit 120, the state determination unit 130, and the impact determination unit 180. The predicted state acquisition unit 110 acquires the predicted surface layer state. The predicted surface layer state is sensor information related to a surface of the structure on the ground surface and is predicted based on the pre-event sensor information measured before the event related to the ground of the structure. The predicted surface layer state is a surface layer state of the structure after the event. The sensor information acquisition unit 120 acquires the post-event sensor information measured after the event. The state determination unit 130 determines the post-event surface layer state of the structure based on the post-event sensor information. The impact determination unit 180 determines the impact of the event on the structure based on the predicted surface layer state and the post-event surface layer state.

The sensor information is information related to the surface of the structure. For example, the sensor information is an image of the surface of the structure such as an image of a surface of a road. However, the sensor information is not limited to the image. For example, the sensor information may be the magnitude of vibration, speed, or acceleration occurring due to unevenness of the road surface. Alternatively, the sensor information may be three-dimensional data such as data measured using radio detecting and ranging (RADAR) or light detection and ranging (LiDAR). The sensor information may include not one information item but a plurality of information items such as a combination of the image and the acceleration.

Other information may be attached to the sensor information. Hereinafter, examples of information attached to the sensor information will be described.

### Identification Information

Information for identifying the sensor information may be attached to the sensor information. For example, an identifier may be attached to the sensor information. Alternatively, in a case where the sensor information is measured at a plurality of positions, the position where the sensor information has been measured may be attached to the sensor information. The position may be a two-dimensional position, such as latitude and longitude, or may be a three-dimensional position including height. Alternatively, in a case where the sensor information is measured at a plurality of time points, the time where the sensor information has been measured may be attached to the sensor information. For example, the impact determination system 12 may identify the sensor information, using the position and the time attached to the sensor information. As described above, the position and the time attached to the sensor information may be used to identify the sensor information.

### Measurement Device Information

Information that impacts the measured sensor information may be attached to the sensor information. For example, information related to a device for measuring the sensor information may be attached to the sensor information. The device for measuring the sensor information is, for example, a dashboard camera (dashcam). Hereinafter, the devices for measuring the sensor information are collectively referred to as a “sensor information measurement device”. For example, the information related to the sensor information measurement device may include at least one of a device name, a model name, an attachment position, and an imaging direction. Alternatively, information related to a sensor of the sensor information measurement device may be attached to the sensor information. For example, the information related to the sensor may include at least one of the type, specifications, and performance of the sensor. For example, in a case where the sensor is a camera, the information related to the sensor may include at least one of the focal length, aperture, diaphragm, shutter speed, and number of pixels of the camera.

### Moving Object Information

In a case where the sensor information measurement device is mounted on a moving object, information related to the moving object may be attached to the sensor information. For example, the information related to the moving object may include at least one of the name, model number, and type of the moving object. Alternatively, information related to the operation of the moving object may be attached to the sensor information. For example, in a case where the moving object is a vehicle, the information related to the operation of the moving object may include operation information of at least one of an accelerator pedal, a brake pedal, a shift lever, a steering wheel, a wiper, a blinker, and the opening and closing of a door.

### Peripheral Information

Peripheral information in a case where the sensor information is measured may be attached to the sensor information. The peripheral information may include, for example, at least one of surrounding weather, temperature, humidity, illuminance, a degree of congestion, and voice.

### Worker Information

Information related to a worker who is in charge of measuring the sensor information may be attached to the sensor information. For example, the information related to the worker may include at least one of the name and identifier of the worker. Alternatively, information added by the worker may be attached to the sensor information. For example, the information added by the worker may include a comment related to at least one of the structure and the sensor information.

The “surface layer” of the structure is a range in which the state can be checked from the surface of the structure. The surface of the structure is not limited to the road surface through which a vehicle or the like passes and may be a surface in contact with the outside, such as a side wall and a ceiling of a tunnel. For example, the surface layer is a portion including a surface and a range from the surface to a predetermined depth. For example, in a case where the structure includes a plurality of layers, the surface layer is a layer of the surface of the structure or a predetermined layer including the layer of the surface. Hereinafter, a portion excluding the surface layer of the structure is referred to as a “deep layer”. For example, in a case where the structure is an asphalt-paved road, the surface layer is a layer of asphalt. In this case, for example, the deep layer is a crushed stone layer, a road bed, and a road body. However, the surface layer and the deep layer are not limited to the above. For example, in a case where the structure is an asphalt-paved road, the surface layer may be an asphalt layer and a crushed stone layer. In this case, the deep layer is a road bed and a road body.

The “surface layer state” is a state of the surface layer of the structure. For example, the “surface layer state” is determined based on the sensor information. For example, the determined surface layer state is deterioration related to the road. The deterioration of the road is, for example, at least one of a crack, a rut, a pothole, deterioration of a road surface seal, and fraying of a peripheral portion of the seal. The surface layer state may be a type of deterioration. For example, the surface layer state may be a type of deterioration such as a vertical crack, a horizontal crack, or an alligator crack. Alternatively, the surface layer state may be deterioration of an object that is provided on a surface of a road, such as scratching of a white line of a road surface and a road surface sign or breakage of a sign. Alternatively, the surface layer state may be a change in the surface, such as abrasion of the surface layer, instead of breakage such as a crack. Alternatively, the surface layer state may be a state of a processed portion of the road surface such as a straight groove for drainage in the road surface or a circular groove for slip prevention in a slope. Alternatively, a “deterioration degree” that is a degree of deterioration may be used as the surface layer state. General deterioration degrees on roads, runways, and the like include the following.
Crack rate: a value obtained by dividing the area of a crack by the area of an object to be investigated.
Amount of rutting: a height from a rutting portion to a protrusion in a predetermined range. In many cases, 20 m is used as the predetermined range.
International Roughness Index (IRI): an evaluation index for unevenness of a paved road proposed by the World Bank in 1986.
BBI (Boeing Bump Index): a flatness index adopted by the Federal Aviation Administration in 2009.

As an example of the determination of the impact in the impact determination system 11, a case of tunnel construction under a road will be described. In this description, a structure and the like are as follows.
Structure: road
Event: tunnel construction under road
Sensor information: image of road
Surface layer state: crack rate of road

In this case, the predicted state acquisition unit 110 acquires, as the predicted surface layer state, a crack rate after the tunnel construction that has been predicted based on the image of the road measured before the tunnel construction. Hereinafter, the crack rate after the tunnel construction predicted based on the image of the road before the tunnel construction is referred to as a “predicted crack rate”. The sensor information acquisition unit 120 acquires the image of the road after the tunnel construction as the post-event sensor information. The state determination unit 130 determines, as the post-event surface layer state, the crack rate after the tunnel construction based on the image of the road after the tunnel construction. Hereinafter, the crack rate determined based on the image of the road after the tunnel construction is referred to as a “post-construction crack rate”. The impact determination unit 180 determines the impact of the tunnel construction on the road based on the predicted crack rate and the post-construction crack rate. For example, in a case where the post-construction crack rate is larger than the predicted crack rate by prediction accuracy or more, the impact determination unit 180 determines that the crack of the road has been impacted by the tunnel construction. On the other hand, in a case where the post-construction crack rate is larger than the predicted crack rate, but is within the range of prediction accuracy, or in a case where the post-construction crack rate is smaller than the predicted crack rate, the impact determination unit 180 determines that the crack of the road has not been impacted by the tunnel construction.

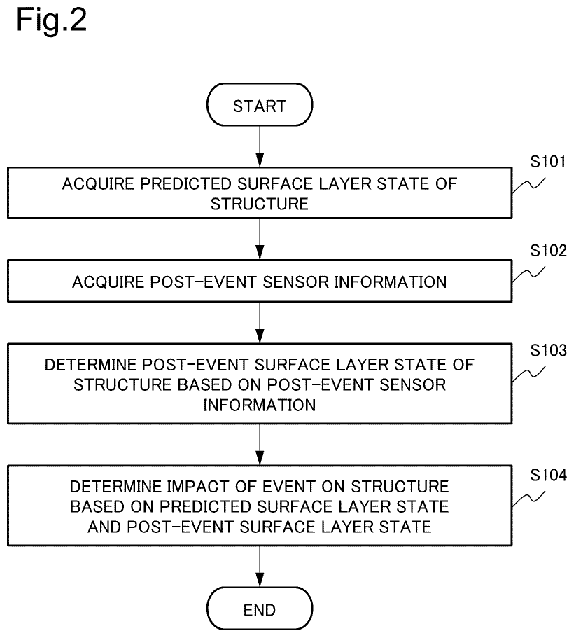

FIG. 2 is a flowchart illustrating an example of the operation of the impact determination system 11 according to the first example embodiment. The predicted state acquisition unit 110 acquires the predicted surface layer state of the structure (step S101). The predicted surface layer state is a surface layer state of the structure after the event that has been predicted based on the pre-event sensor information. The pre-event sensor information is sensor information that is related to the surface of the structure and has been measured before the event related to the ground of the structure. The sensor information acquisition unit 120 acquires the post-event sensor information measured after the event (step S102). The state determination unit 130 determines the post-event surface layer state of the structure based on the post-event sensor information (step S103). The impact determination unit 180 determines the impact of the event on the structure based on the predicted surface layer state and the post-event surface layer state (step S104).

As described above, the impact determination system 11 determines the impact of the event related to the ground on the structure on the ground surface, using the predicted surface layer state based on the pre-event sensor information and the post-event surface layer state based on the post-event sensor information. That is, the impact determination system 11 determines the impact of the event on the structure using the predicted surface layer state predicted based on the pre-event sensor information in addition to the post-event surface layer state determined based on the post-event sensor information. Therefore, the impact determination system 11 can more appropriately determine the impact of the event on the structure.

The predicted state acquisition unit 110, the state determination unit 130, and the impact determination unit 180 of the impact determination system 11 may use a speed that is a rate of change in the surface layer state or acceleration that is a rate of change in the speed of the surface layer state in addition to or instead of the surface layer state. For example, in a case where the surface layer state is deterioration, the speed of the surface layer state is a speed at which the deterioration of the surface layer progresses. For example, in a case where a crack is used as the surface layer state, the rate of change in the surface layer state is a rate of increase in the crack rate or a rate at which the area of the crack expands. The speed of the surface layer state and the acceleration of the surface layer state can be calculated based on the accumulated data.

### Second Example Embodiment

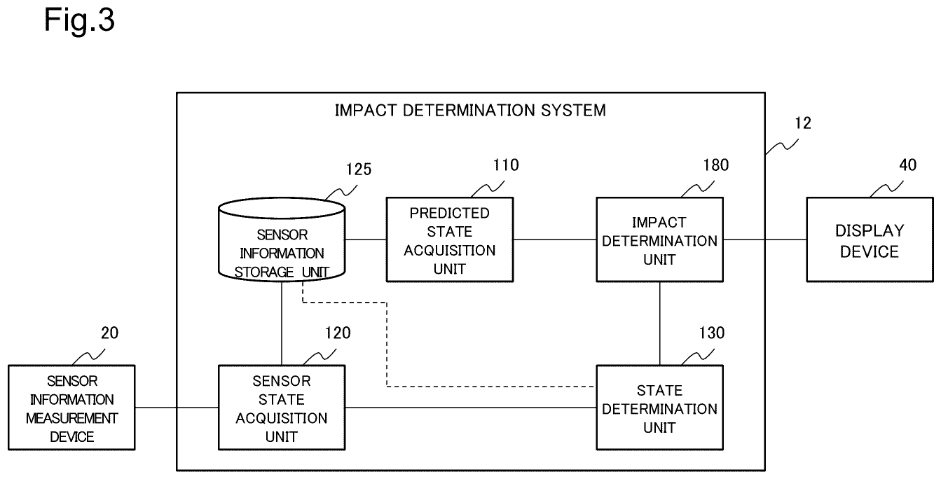

An impact determination system 12 according to a second example embodiment will be described with reference to the drawings. FIG. 3 is a block diagram illustrating an example of a configuration of the impact determination system 12 according to the second example embodiment. In FIG. 3, the impact determination system 12 is connected to a sensor information measurement device 20 and a display device 40. The number of components in FIG. 3 is an example and is not limited to the number illustrated in FIG. 3. For example, the impact determination system 12 may be connected to a plurality of sensor information measurement devices 20.

### (1) Sensor Information Measurement Device 20

The sensor information measurement device 20 measures sensor information. For example, the sensor information measurement device 20 measures sensor information related to a surface of a structure. For example, the sensor information measurement device 20 is mounted on or pulled by a moving object that is moved on an upper surface of the structure or in the vicinity of the structure and measures the sensor information. For example, the sensor information measurement device 20 is a dashcam that is mounted on a vehicle as an example of the moving object and that measures the image of the road as an example of the sensor information. Alternatively, the sensor information measurement device 20 may be a vibration meter that measures vibration of the vehicle or an acceleration meter that measures the acceleration of the vibration of the vehicle. The sensor information measurement device 20 may be a fixed device, such as a fixed camera, that is installed on the road or beside the road. The sensor information measurement device 20 may be a device capable of changing performance related to the measurement of the sensor information such as an imaging direction and a focal length.

The moving object equipped with the sensor information measurement device 20 is not limited to the vehicle. For example, an unmanned aerial vehicle (drone) may be equipped with the sensor information measurement device 20 and moved. Alternatively, a person may carry the sensor information measurement device 20 like a wearable dashcam. In the following description, as an example, a dashcam is used as the sensor information measurement device 20, and an image of a surface of a structure is used as the sensor information. A vehicle is used as an example of the moving object.

### (2) Impact Determination System 12

The impact determination system 12 includes a predicted state acquisition unit 110, a sensor information acquisition unit 120, a sensor information storage unit 125, a state determination unit 130, and an impact determination unit 180.

### (2-1) Sensor Information Acquisition Unit 120

The sensor information acquisition unit 120 acquires the pre-event sensor information and the post-event sensor information. For example, the sensor information acquisition unit 120 acquires the pre-event sensor information and the post-event sensor information from the sensor information measurement device 20 mounted on the moving object. The sensor information acquisition unit 120 may acquire the pre-event sensor information and the post-event sensor information at each of a plurality of positions. The sensor information acquisition unit 120 may acquire the post-event sensor information at each of a plurality of time points after the event. The sensor information acquisition unit 120 may acquire the pre-event sensor information at each of a plurality of time points before the event. Hereinafter, the “pre-event sensor information” and the “post-event sensor information” may be collectively referred to simply as “sensor information” except a case where they do not need to be particularly distinguished from each other, in order to avoid complication of description. The sensor information acquisition unit 120 may acquire the time when the sensor information has been measured. Hereinafter, the time when the sensor information has been measured is referred to as “time of the sensor information”.

A method for acquiring the sensor information is not limited. Various methods can be assumed as the method for acquiring the sensor information. For example, the sensor information acquisition unit 120 may output the position of the structure to the sensor information measurement device 20 and acquire the sensor information associated to the output position. Alternatively, the sensor information acquisition unit 120 may acquire sensor information items including sensor information of a target structure and sensor information items of other structures from the sensor information measurement device 20 and extract sensor information associated to the position of the target structure from the acquired sensor information items. The sensor information acquisition unit 120 may acquire the sensor information at each of a plurality of positions associated to the structure in such a way as to cover the entire structure.

Alternatively, the sensor information acquisition unit 120 may acquire the sensor information in a partial range of the structure. For example, in a case where the structure is a road, the sensor information acquisition unit 120 may acquire the sensor information related to the road designated in advance. Alternatively, in a case where the range in which the event has occurred is specified, the sensor information acquisition unit 120 may acquire the sensor information of the range in which the event has occurred.

In a case where the sensor information acquisition unit 120 acquires the sensor information items at a plurality of positions, detection ranges of at least some of the sensor information items may overlap each other. Alternatively, the sensor information acquisition unit 120 may acquire sensor information stored in a storage device (not illustrated) as the at least some sensor information items. In a case where the impact determination system 12 is connected to a plurality of sensor information measurement devices 20, the sensor information acquisition unit 120 may acquire sensor information from the plurality of sensor information measurement devices 20. In this case, the sensor information acquisition unit 120 may acquire the pre-event sensor information and the post-event sensor information from different sensor information measurement devices 20.

Then, the sensor information acquisition unit 120 stores the pre-event sensor information in the sensor information storage unit 125. The sensor information acquisition unit 120 outputs the post-event sensor information to the state determination unit 130. The sensor information acquisition unit 120 may store the post-event sensor information in the sensor information storage unit 125. Alternatively, the sensor information acquisition unit 120 may output the pre-event sensor information to the state determination unit 130.

### (2-2) Sensor Information Storage Unit 125

The sensor information storage unit 125 stores the pre-event sensor information acquired by the sensor information acquisition unit 120. In a case where the pre-event sensor information items at a plurality of time points are stored, the sensor information storage unit 125 may store the pre-event sensor information items as a history. In a case where the sensor information acquisition unit 120 acquires the pre-event sensor information items at a plurality of positions, the sensor information storage unit 125 may store the pre-event sensor information at each of the plurality of positions. Then, the sensor information storage unit 125 outputs the pre-event sensor information to the predicted state acquisition unit 110. In a case where the post-event sensor information is stored, the sensor information storage unit 125 may output the post-event sensor information to the state determination unit 130.

### (2-3) Predicted State Acquisition Unit 110

The predicted state acquisition unit 110 acquires the predicted surface layer state based on the pre-event sensor information stored in the sensor information storage unit 125. For example, the predicted state acquisition unit 110 may apply the pre-event sensor information to a prediction model acquired from machine learning using the past sensor information and surface layer state to acquire the predicted surface layer state. Alternatively, the predicted state acquisition unit 110 may apply the pre-event sensor information to a predetermined prediction expression to acquire the predicted surface layer state. Alternatively, the predicted state acquisition unit 110 may output the pre-event sensor information to a configuration or a device (not illustrated) and acquire the predicted surface layer state from the configuration or the device. Specifically, for example, the predicted state acquisition unit 110 acquires the predicted crack rate based on the image of the road measured before the tunnel construction. In a case where the sensor information storage unit 125 stores the pre-event sensor information items at a plurality of positions, the predicted state acquisition unit 110 may acquire the predicted surface layer state at each of the plurality of positions.

The predicted state acquisition unit 110 acquires a surface layer state at a certain specified time point as the predicted surface layer state to be acquired. Hereinafter, the specified time point is referred to as a “time point of prediction”. The time point of prediction used by the predicted state acquisition unit 110 is not limited. For example, the predicted state acquisition unit 110 may use a preset time point or a time point designated by the user as the time point of prediction. Alternatively, the predicted state acquisition unit 110 may use the time when the post-event sensor information acquired by the sensor information acquisition unit 120 has been measured as the time point of prediction. That is, the predicted state acquisition unit 110 may acquire the predicted surface layer state at a time point associated to the time of the post-event sensor information. The predicted state acquisition unit 110 may acquire the predicted surface layer state at each of a plurality of time points after the event instead of one time point.

The predicted state acquisition unit 110 may acquire the predicted surface layer state based on the surface layer state determined based on the sensor information measured before the event instead of the pre-event sensor information. Hereinafter, the surface layer state determined based on the sensor information measured before the event is referred to as a “pre-event surface layer state”. For example, the predicted state acquisition unit 110 may acquire the predicted surface layer state based on the pre-event surface layer state determined by the state determination unit 130 based on the stored pre-event sensor information. Even in this case, the predicted state acquisition unit 110 may acquire the predicted surface layer state using a predetermined prediction model or prediction expression. Alternatively, the predicted state acquisition unit 110 may acquire the predicted surface layer state using a configuration or a device (not illustrated).

### (2-4) State Determination Unit 130

The state determination unit 130 determines the post-event surface layer state of the structure based on the post-event sensor information. For example, the state determination unit 130 may acquire the post-event sensor information from the sensor information acquisition unit 120 and determine the post-event surface layer state based on the acquired post-event sensor information. Alternatively, when determining the post-event surface layer state, the state determination unit 130 may acquire the post-event sensor information from the sensor information acquisition unit 120 or may acquire the post-event sensor information stored in the sensor information storage unit 125. In a case where the sensor information acquisition unit 120 acquires the post-event sensor information items at a plurality of positions, the state determination unit 130 may determine the post-event surface layer state at each of the plurality of positions.

The state determination unit 130 may determine the post-event surface layer state based on the post-event sensor information measured at the designated time. For example, the state determination unit 130 may acquire the post-event sensor information at the time designated by the user from the sensor information storage unit 125 and determine the post-event surface layer state based on the acquired post-event sensor information. In a case where the sensor information acquisition unit 120 acquires the post-event sensor information items at a plurality of time points after the event, the state determination unit 130 may determine the post-event surface layer state at each of the plurality of time points after the event based on the post-event sensor information at each of the plurality of time points after the event.

### (2-5) Impact Determination Unit 180

The impact determination unit 180 determines the impact of the event on the structure based on the predicted surface layer state and the post-event surface layer state. For example, in a case where the deterioration of the post-event surface layer state from the predicted surface layer state is equal to or greater than a predetermined value, the impact determination unit 180 determines that the structure is impacted by the event. The deterioration equal to or greater than the predetermined value may be appropriately defined according to, for example, a structure, sensor information, a surface layer state to be determined, determination and prediction errors, and the like. For example, in a case where the event is tunnel construction, the impact determination unit 180 compares the predicted crack rate with the post-construction crack rate in the range of the tunnel construction. Then, in a case where the post-construction crack rate is larger than the predicted crack rate in at least a portion of the range of the tunnel construction, the impact determination unit 180 determines that there is an impact of the tunnel construction. The impact determination unit 180 may determine that there is the impact of the tunnel construction in a case where the post-construction crack rate is larger than the predicted crack rate by a predetermined value or more in consideration of the prediction and determination errors.

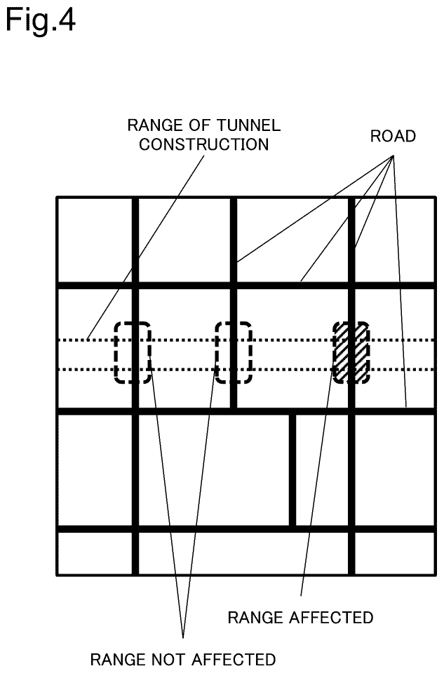

The impact determination unit 180 may determine the range impacted by the event. For example, the impact determination unit 180 may determine the range in which the deterioration of the post-event surface layer state from the predicted surface layer state is equal to or greater than the predetermined value as the range impacted by the event. For example, the impact determination unit 180 may determine a range in which the post-event crack rate is larger than the predicted crack rate by a predetermined value or more as the range impacted by the tunnel construction. FIG. 4 is a diagram illustrating an example of the range determined to be impacted by the event. In FIG. 4, three ranges represented by broken lines are the ranges of tunnel construction and are ranges in which there are roads as the structures to be determined. Then, the right hatched range is the range in which the post-event crack rate is larger than the predicted crack rate by the predetermined value or more. Therefore, the impact determination unit 180 determines the right hatched range represented by the broken line as the range impacted by the tunnel construction. The impact determination unit 180 may determine a range that is not impacted by the event. For example, the impact determination unit 180 may determine a range in which the difference between the post-construction crack rate and the predicted crack rate is less than a predetermined value and a range in which the post-construction crack rate is less than the predicted crack rate as the range that is not impacted by the tunnel construction. For example, the impact determination unit 180 may determine two ranges that are not hatched and are represented by the broken lines in FIG. 4 as the range that is not impacted by the tunnel construction.

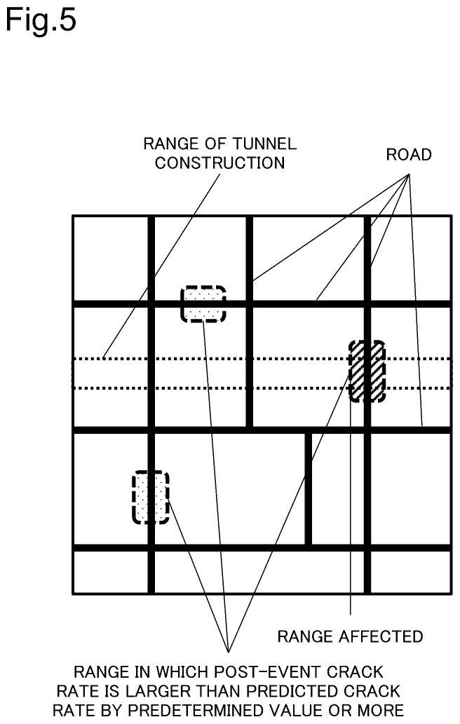

The impact determination unit 180 may determine the range impacted by the event based on the comparison between the predicted surface layer state and the post-event surface layer state in the entire structure. For example, the impact determination unit 180 compares the predicted crack rate with the post-event crack rate in the entire road. Then, the impact determination unit 180 extracts a range in which the post-event crack rate is larger than the predicted crack rate by a predetermined value or more. Then, the impact determination unit 180 may determine the range of the tunnel construction as the range impacted by the tunnel construction in the extracted range. FIG. 5 is a diagram illustrating an example of a case where the determination is executed in the entire range. In FIG. 5, the impact determination unit 180 determines three ranges as the range in which the post-event crack rate is larger than the predicted crack rate by a predetermined value or more. Then, the impact determination unit 180 determines the right hatched range as the range impacted by the tunnel construction based on the range of the tunnel construction.

The impact determination unit 180 may determine the impact of the event based on the relationship between the predicted surface layer states and the post-event surface layer states at a plurality of positions. For example, in a case where the predicted state acquisition unit 110 acquires the predicted surface layer states at a plurality of positions and the state determination unit 130 determines the associated post-event surface layer state, the impact determination unit 180 may determine the impact of the event based on the predicted surface layer state and the post-event surface layer state at each of the plurality of positions. For example, the impact determination unit 180 may determine the impact of the event according to the degree of matching between the range in which the deterioration of the post-event surface layer state from the predicted surface layer state is equal to or greater than a predetermined value and the range in which the event has occurred. For example, the impact determination unit 180 may determine the impact of the event based on the predicted surface layer state, the post-event surface layer state, and the range in which the event has occurred. As an example, a case where the crack rate is used as the predicted surface layer state and the post-event surface layer state will be described. For example, in a case where the range in which the post-construction crack rate is larger than the predicted crack rate substantially overlaps the range of the construction and has a similar shape to the range of the construction, there is a high possibility that the crack will occur under the impact of the construction. Therefore, in this case, the impact determination unit 180 may determine that the crack is impacted by the construction. As described above, in a case where the predicted surface layer states and the post-event surface layer states at a plurality of positions are used, the impact determination unit 180 can more appropriately determine the impact of the event.

The impact determination unit 180 may determine the impact of the event based on the relationship between the predicted surface layer states and the post-event surface layer states at a plurality of time points and changes in the predicted surface layer states and the post-event surface layer states over time. For example, in a case where the predicted state acquisition unit 110 acquires the predicted surface layer states at a plurality of time points and the state determination unit 130 determines the associated post-event surface layer state, the impact determination unit 180 may determine the impact of the event based on the predicted surface layer state and the post-event surface layer state at each of the plurality of time points. For example, in a case where the difference between the predicted crack rate and the post-construction crack rate increases with the lapse of time after the event, the impact determination unit 180 may determine that the crack is impacted by the construction.

The impact determination unit 180 may determine the impact of the event based on the relationship between the predicted surface layer states and the post-event surface layer states at a plurality of positions and a plurality of time points and changes in the predicted surface layer states and the post-event surface layer states over time. For example, in a case where the range in which the difference between the predicted crack rate and the post-construction crack rate is large expands in an excavation direction of the tunnel construction with the progress of the tunnel construction, there is a high possibility that the crack will be impacted by the tunnel construction. Therefore, in a case where the range in which the difference between the predicted crack rate and the post-construction crack rate is large expands in the excavation direction of the tunnel construction as the tunnel construction progresses with the lapse of time, the impact determination unit 180 may determine that the crack is impacted by the construction.

The impact determination unit 180 may use other information in the determination of the impact. For example, in the determination of the impact, the impact determination unit 180 may use at least one of a geological layer of the ground of the structure, a range in which the event has occurred, a topography around the structure, a geology, soil, weather, a construction type, and a construction method. Examples of the topography include artificial flat land, cut land, reclaimed land, fill-up land, and a gravel collection site. Examples of the geology include soil, a sedimentary rock, an igneous rock, lava, a metamorphic rock, and a mineral vein. The examples of the weather include fine rain, temperature, humidity, precipitation, and snow accumulation. Examples of the construction type include civil engineering works, architectural works, paving works, and water facility works. Examples of the construction method include a shield method, a tunnel boring machine (TBM) method, and a new Austrian tunneling method (NATM).

Then, the impact determination unit 180 outputs a determination result. For example, the impact determination unit 180 outputs the determination result to the display device 40 or the like. The display device 40 is not particularly limited as long as it is a device that displays the determination result. The content of the determination result output by the impact determination unit 180 is not particularly limited. For example, the impact determination unit 180 may output a determination result for the entire structure as the determination result. Alternatively, the impact determination unit 180 may output a determination result for a portion of the structure. For example, the impact determination unit 180 may output, as the determination result, the range determined to be impacted by the event. The impact determination unit 180 may output at least one of the predicted surface layer state and the post-event surface layer state. Alternatively, the impact determination unit 180 may output at least one of the pre-event sensor information and the post-event sensor information. For example, the impact determination unit 180 may output the determination result of the range determined to be impacted by the event, the predicted surface layer state, and the post-event surface layer state. Alternatively, the impact determination unit 180 may output the determination result of the range determined to be impacted by the event, the pre-event sensor information, and the post-event sensor information.

### (2-6) Impact Determination System 12

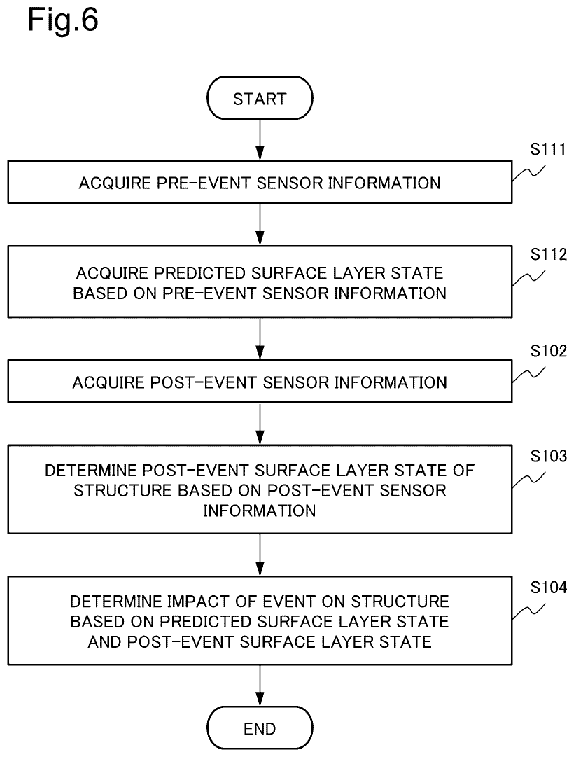

An operation of the impact determination system 12 will be described with reference to the drawings. FIG. 6 is a flowchart illustrating an example of the operation of the impact determination system 12 according to the second example embodiment. The sensor information acquisition unit 120 acquires the pre-event sensor information (step S111). Then, the sensor information acquisition unit 120 stores the pre-event sensor information in the sensor information storage unit 125. The predicted state acquisition unit 110 acquires the predicted surface layer state based on the pre-event sensor information (step S112). The sensor information acquisition unit 120 further acquires the post-event sensor information (step S102). The state determination unit 130 determines the post-event surface layer state of the structure based on the post-event sensor information (step S103). The impact determination unit 180 determines the impact of the event on the structure based on the predicted surface layer state and the post-event surface layer state (step S104).

The impact determination system 12 may repeat the following operation according to a management cycle of the structure. The sensor information acquisition unit 120 reacquires the post-event sensor information. The state determination unit 130 redetermines the post-event surface layer state based on the reacquired post-event sensor information. The predicted state acquisition unit 110 reacquires the predicted surface layer state at the time associated to the post-event sensor information. Then, the impact determination unit 180 redetermines the impact of the event based on the reacquired predicted surface layer state and the redetermined post-event surface layer state. In this case, for the next operation, the sensor information acquisition unit 120 may add the reacquired post-event sensor information to the pre-event sensor information. In this case, the predicted state acquisition unit 110 may use the pre-event sensor information, to which the currently acquired post-event sensor information has been added, in the acquisition of the next predicted surface layer state.

Alternatively, the impact determination system 12 may repeat the operation according to a predetermined cycle such as every month or week or an update cycle of the sensor information. Alternatively, the impact determination system 12 may repeat the operation in response to an instruction from the user.

Similarly to the impact determination system 11, the impact determination system 12 may use a speed that is a rate of change in the surface layer state or acceleration that is a rate of change in the speed of the surface layer state, in addition to or instead of the surface layer state.

### (3) Display Device

The display device 40 displays the determination result related to the impact of the event from the impact determination unit 180. For example, as illustrated in FIG. 4 or 5, the display device 40 may display the determination result of the impact of the tunnel construction on the road. As described above, the type, installation location, and the like of the display device 40 are not important as long as the display device 40 can display the determination result. The relationship between the impact determination system 12 and the display device 40 is not particularly limited.

The display device 40 may display at least one of the sensor information and the surface layer state in addition to the determination result. For example, the display device 40 may display the image of the road in addition to the determination result. Alternatively, the display device 40 may display the predicted surface layer state and the post-event surface layer state in addition to the determination result.

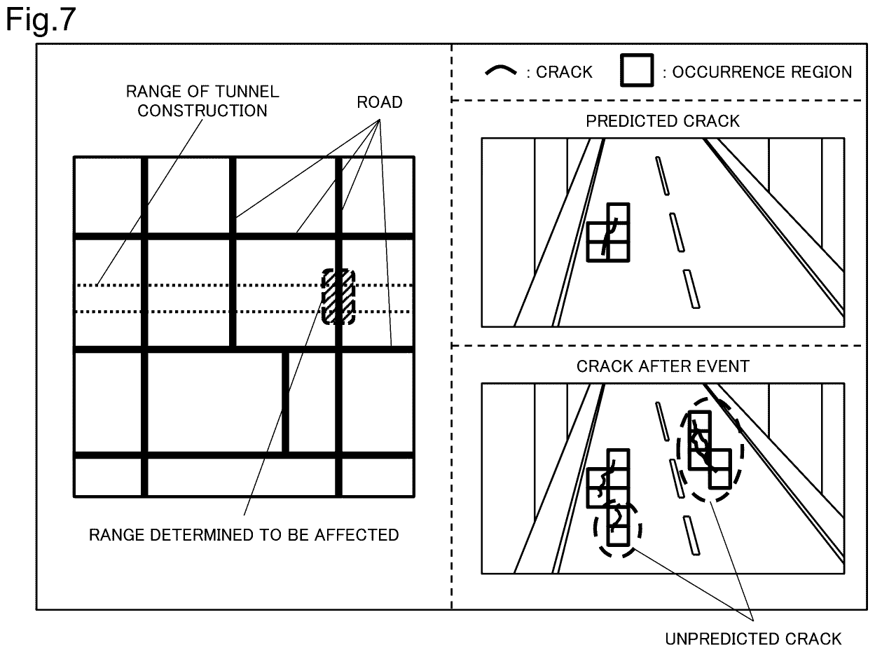

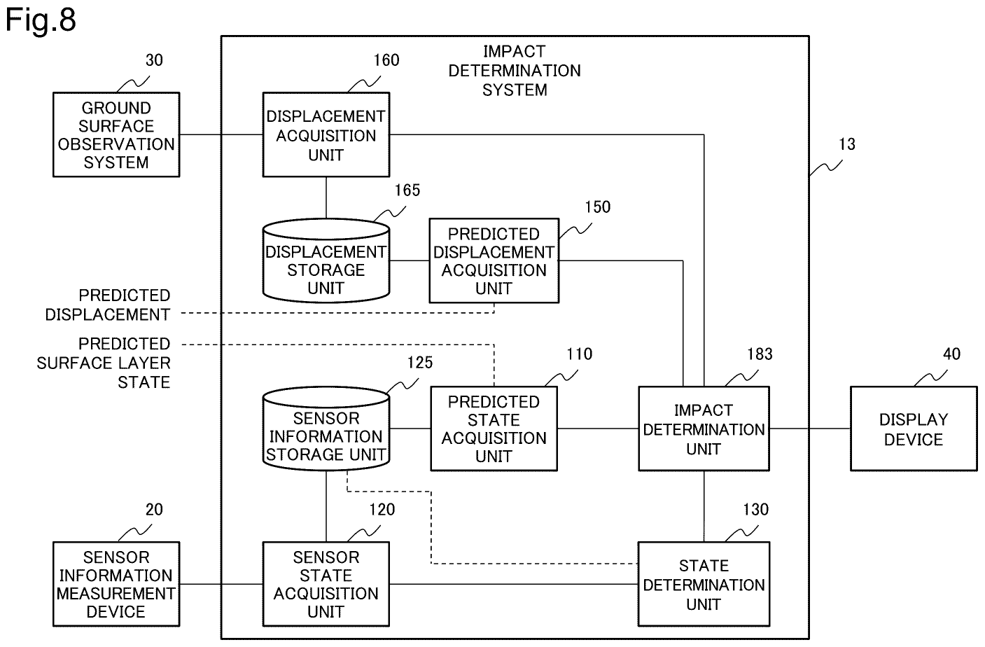

FIG. 7 is a diagram illustrating an example of the display of the surface layer state. In FIG. 7, the display device 40 displays the range of the road determined to be impacted by the event in FIG. 4 or 5 on the left side, displays the predicted crack on the upper right side, and displays the determined crack on the lower right side. In FIG. 7, the display device 40 displays squares indicating the position of the crack for easy understanding of the position of the crack. Referring to the upper right view and the lower right view of FIG. 8, two cracks surrounded by dashed ellipses in the lower right view of FIG. 8 are unpredicted cracks. That is, the cracks are estimated to occur under the impact of the tunnel construction.

### Third Example Embodiment

An impact determination system 13 according to a third example embodiment will be described with reference to the drawings. FIG. 8 is a diagram illustrating an example of a configuration of the impact determination system 13 according to the third example embodiment. In FIG. 8, the impact determination system 13 is further connected to a ground surface observation system 30 as compared to the impact determination system 12. Therefore, hereinafter, the ground surface observation system 30 and the impact determination system 13 will be mainly described.

### (1) Ground Surface Observation System 30

The ground surface observation system 30 observes a ground surface including a structure using an observation device and outputs an observation result to the impact determination system 13. For example, the ground surface observation system 30 includes a synthetic aperture radar (SAR) that observes the ground surface including the structure and outputs an image of the ground surface as the observation result. The observation device in the ground surface observation system 30 is, for example, an SAR mounted on an artificial satellite, an aircraft, or an unmanned aerial vehicle (drone). However, the observation device is not limited to the SAR and may be, for example, an optical sensor or a laser measurement device. The ground surface observation system 30 may output the observation result using a plurality of frequencies (multiple spectra) instead of one frequency. The ground surface observation system 30 may analyze the observation result and output an analysis result. For example, the ground surface observation system 30 may output the displacement of the ground surface as the analysis result.

### (2) Impact Determination System 13

The impact determination system 13 includes an impact determination unit 183 instead of the impact determination unit 180 in the configuration of the impact determination system 12 and further includes a displacement acquisition unit 160, a displacement storage unit 165, and a predicted displacement acquisition unit 150. Therefore, in the following description, configurations and operations different from those of the second example embodiment will be mainly described, and a description of the same configurations and operations as those of the second example embodiment will be appropriately omitted. The predicted state acquisition unit 110 may acquire the predicted surface layer state as in the first example embodiment or may acquire the predicted surface layer state based on the sensor information stored in the sensor information storage unit 125 as in the second example embodiment.

### (2-1) Displacement Acquisition Unit 160

The displacement acquisition unit 160 acquires a displacement of a structure provided on the ground surface. The displacements are a pre-event displacement and a post-event displacement. The post-event displacement is a displacement based on the observation result before the event. The post-event displacement is a displacement based on the observation result after the event. The displacement acquisition unit 160 may acquire the pre-event displacement and the post-event displacement at each of a plurality of positions. The displacement acquisition unit 160 may acquire the post-event displacements at a plurality of time points after the event. Hereinafter, the “pre-event displacement” and the “post-event displacement” may be collectively referred to simply as a “displacement” except a case where they do not need to be particularly distinguished from each other, in order to avoid complication of description.

The displacement acquisition unit 160 acquires the displacement of the structure based on the observation result of the ground surface observation system 30 including an SAR that observes the ground surface including the structure. As described above, the displacement is acquired based on the observation result. Therefore, in the following description, the time of observation to be the basis of analysis is used as the time of displacement.

The displacement acquisition unit 160 may acquire the displacement based on the observation results at a plurality of time points. For example, displacement acquisition unit 160 acquires images of the ground surface at two different time points from ground surface observation system 30. Then, the displacement acquisition unit 160 acquires the displacement of the ground surface between the two time points from analysis using the images of the ground surface at the two different time points. The displacement acquired as the result of the analysis is a displacement from the previous observation to the subsequent observation. Therefore, in this case, the time of displacement is the time of the subsequent observation.

In a case where the ground surface observation system 30 outputs the displacement of the ground surface as the result of analyzing the observation result, the displacement acquisition unit 160 may acquire the displacement of the ground surface from the ground surface observation system 30. As described above, the displacement acquisition unit 160 may analyze the observation result acquired from the ground surface observation system 30 to acquire the displacement or may acquire the displacement from the ground surface observation system 30. Then, in the following description, these will be collectively described as “the displacement acquisition unit 160 acquires the displacement of the structure on the ground surface from the ground surface observation system 30”.

A method for acquiring the displacement is not limited. Various methods can be assumed as the method for acquiring the displacement. For example, when acquiring the displacement, the displacement acquisition unit 160 may output the position of the structure to the ground surface observation system 30 and acquire the displacement associated to the output position. Alternatively, the displacement acquisition unit 160 may acquire displacements including the displacement of a target structure and the displacements of other structures from the ground surface observation system 30 and extract the displacement of the target structure from the acquired displacements. In a case where the displacement acquisition unit 160 acquires the displacements at a plurality of positions, detection ranges of at least some displacements may overlap each other. Alternatively, the displacement acquisition unit 160 may acquire displacements stored in a storage device (not illustrated) as the at least some displacements.

In a case where the structure is wider than the spatial resolution of the displacement, the displacements at the plurality of positions are the displacement associated to the structure. Therefore, in a case where the structure is wider than the spatial resolution of the displacement, the displacement acquisition unit 160 may acquire the displacement at each of the plurality of positions associated to the structure in such a way as to cover the entire structure. The spatial resolution is the minimum distance at which two objects at a close distance can be distinguished as two objects. For example, the spatial resolution of the displacement is the minimum distance between two displacements.

The displacement acquisition unit 160 may acquire the displacement of a partial range of the structure. For example, in a case where the structure is a road, the displacement acquisition unit 160 may acquire a displacement related to the road designated in advance. Alternatively, in a case where the range in which the event has occurred is specified, the displacement acquisition unit 160 may acquire the displacement in the range in which the event has occurred.

Then, the displacement acquisition unit 160 stores the pre-event displacement in the displacement storage unit 165. The displacement acquisition unit 160 outputs the post-event displacement to the impact determination unit 183. The displacement acquisition unit 160 may store the post-event displacement in the displacement storage unit 165. Alternatively, the displacement acquisition unit 160 may output the pre-event displacement to the impact determination unit 183.

The displacement of the structure is acquired from the analysis of the observation result of the ground surface observation system 30. However, the analysis using the observation result is not limited to the analysis for acquiring the displacement of the ground surface and includes analysis of, for example, a change in the strength of the ground surface, a factor of the displacement of the ground surface, the magnitude of a risk based on the displacement of the ground surface, and a difference from prediction based on the past displacement of the ground surface. Therefore, the impact determination system 13 may determine the impact of the event using, for example, a change in the strength of the ground surface, instead of the displacement of the ground surface. Even in a case where the change in the strength of the ground surface or the like is used instead of the displacement of the ground surface, the displacement acquisition unit 160 may acquire the change in the strength of the ground surface or the like from the ground surface observation system 30.

In a case where the ground surface observation system 30 performs observation using multiple spectra, the displacement acquisition unit 160 can acquire the type of the ground surface in addition to the displacement of the ground surface. Therefore, the impact determination system 13 may determine the impact of the event using the type of the ground surface in addition to the displacement on the ground surface. The type of the ground surface that can be acquired is determined according to the frequency to be used. For example, the type of the ground surface includes at least one of a water surface, mud, garbage, dry soil, grassland, forest, farmland, and snow cover. Even in this case, the displacement acquisition unit 160 may acquire the type of the ground surface from the ground surface observation system 30. However, in the following description, as an example, the impact determination system 13 determines the impact of the event using the displacement of the ground surface.

Examples of a method for analyzing the image of the ground surface include change extraction, time-series interference analysis, coherent change extraction, differential interference analysis, stereo matching, and combinations thereof. Alternatively, as the method for analyzing the image of the ground surface, there is a method that applies a newly acquired image of the ground surface to an analysis model generated by machine learning using the past image of the ground surface and the past displacement of the ground surface to analyze the displacement of the ground surface.

### (2-2) Displacement Storage Unit 165

The displacement storage unit 165 stores the pre-event displacement acquired by the displacement acquisition unit 160. In a case where the pre-event displacements at a plurality of time points are stored, the displacement storage unit 165 may store the pre-event displacements as a history. In a case where the displacement acquisition unit 160 acquires the pre-event displacements at a plurality of positions, the displacement storage unit 165 may store the pre-event displacement at each of the plurality of positions. Then, the displacement storage unit 165 outputs the pre-event displacement to the predicted displacement acquisition unit 150. In a case where the post-event displacement is stored, the displacement storage unit 165 may output the post-event displacement to the impact determination unit 183.

### (2-3) Predicted Displacement Acquisition Unit 150

The predicted displacement acquisition unit 150 acquires the predicted displacement of the structure after the event that is the displacement of the structure and that has been predicted based on the pre-event displacement acquired before the event. For example, the predicted displacement acquisition unit 150 acquires the post-event displacement predicted based on the pre-event displacement stored in the displacement storage unit 165. Hereinafter, the predicted displacement is referred to as a “predicted displacement”.

For example, the predicted displacement acquisition unit 150 may apply the pre-event displacement to a prediction model acquired from machine learning using the past displacement to acquire the predicted displacement. Alternatively, the predicted displacement acquisition unit 150 may apply the pre-event displacement to a predetermined prediction expression to acquire the predicted displacement. Alternatively, the predicted displacement acquisition unit 150 may acquire the predicted displacement from an external device (not illustrated). Alternatively, the predicted displacement acquisition unit 150 may output the pre-event displacement to a configuration or a device (not illustrated) and acquire the predicted displacement from the configuration or the device. For example, the predicted displacement acquisition unit 150 acquires the predicted displacement of the structure after tunnel construction based on the pre-event displacement acquired before the tunnel construction. In a case where the displacement storage unit 165 stores the pre-event displacements at a plurality of positions, the predicted displacement acquisition unit 150 may acquire the pre-event displacement at each of the plurality of positions.

The predicted displacement acquisition unit 150 acquires a predicted displacement at a specified time point as the predicted displacement to be acquired. Hereinafter, the specified time point is referred to as a “time point of prediction”. The time point of prediction used by the predicted displacement acquisition unit 150 is not limited. For example, the predicted displacement acquisition unit 150 may use a preset time point or a time point designated by the user as the time point of prediction of the predicted displacement. Alternatively, the predicted displacement acquisition unit 150 may use the time of observation used to acquire the post-event displacement, that is, the time of the post-event displacement, as the time point of prediction. The predicted displacement acquisition unit 150 may acquire the predicted displacement at each of a plurality of time points after the event instead of one time point.

### (2-4) Impact Determination Unit 183

The impact determination unit 183 determines the impact of the event on the structure, similarly to the impact determination unit 180. The impact determination unit 183 determines the impact of the event on the structure based on the predicted displacement and the post-event displacement in addition to the predicted surface layer state and the post-event surface layer state. For example, the impact determination unit 183 may use sinking after the tunnel construction and sinking of the road after the tunnel construction that have been predicted based on sinking of the road before the tunnel construction, in addition to the post-construction crack rate and the predicted crack rate. Hereinafter, the sinking after the tunnel construction that has been predicted based on the sinking of the road before the tunnel construction is referred to as “predicted sinking”. Hereinafter, the sinking after the tunnel construction is referred to as “post-construction sinking”. Specifically, for example, the impact determination unit 183 may determine that there is an impact of the construction in a case where both the difference between the post-construction crack rate and the predicted crack rate and the difference between the predicted sinking and the post-construction sinking are large.

The impact determination unit 183 may determine the impact of the event based on the relationship between the predicted displacements and the post-event displacements at a plurality of positions. For example, the impact determination unit 183 may use the predicted displacement and the post-event displacement at each of the plurality of positions. For example, the impact determination unit 183 may determine the impact, using the gradient of the displacement calculated from the displacements at a plurality of positions. In a case where the gradient is used, the impact determination unit 183 may use the direction of the gradient for the determination. For example, the impact determination unit 183 acquires the gradient of the displacement predicted based on the predicted displacements at a plurality of positions. Hereinafter, the gradient of the predicted displacement is referred to as a “predicted gradient”.

The impact determination unit 183 acquires the gradient of the post-event displacement based on the post-event displacements at a plurality of positions. Hereinafter, the gradient of the displacement acquired based on the post-event displacement is referred to as a “post-event gradient”. Then, the impact determination unit 183 may determine the impact of the event based on the predicted gradient and the post-event gradient. For example, in a case where the positions where the difference between the predicted gradient and the post-event gradient is large are arranged along a progress direction of the event, such as a progress direction of the tunnel construction, the impact determination unit 183 may determine that there is the impact of the event.

The direction of the gradient used for the determination may be a direction different from the progress direction of the event. For example, the impact determination unit 183 may determine the impact of the event based on the predicted gradient and the post-event gradient in a direction orthogonal to the progress direction of the event. For example, in a case where the difference between the predicted gradient and the post-event gradient in a width direction of the tunnel construction increases from a peripheral portion toward a central portion of the tunnel construction, the impact determination unit 183 may determine that there is the impact of the event. Alternatively, the gradient direction is not limited to one direction. For example, the impact determination unit 183 may determine the impact of the event based on the predicted gradient and the post-event gradient in at least a portion of the entire range of the construction.

The impact determination unit 183 may determine the impact of the event based on the relationship between the predicted displacements and the post-event displacements at a plurality of time points or changes in the predicted displacements and the post-event displacements over time. For example, the impact determination unit 183 may determine the impact of the event based on the predicted displacement and the post-event displacement at each of the plurality of time points. For example, in a case where the difference between the predicted displacement and the post-event displacement increases with the lapse of a plurality of time points after the event, the impact determination unit 183 may determine that the displacement is impacted by the construction. The impact determination unit 183 may determine the impact of the event based on the predicted displacements and the post-event displacements at a plurality of positions and a plurality of time points. For example, in a case where the range in which the difference between the predicted displacement and the post-event displacement is large expands with the progress of the event, the impact determination unit 183 may determine that the structure is impacted by the event.

The impact determination unit 183 may output at least one of the predicted displacement and the post-event displacement in addition to the determination result. For example, the impact determination unit 183 may output the determination result of the range determined to be impacted by the event, the predicted displacement, and the post-event displacement.

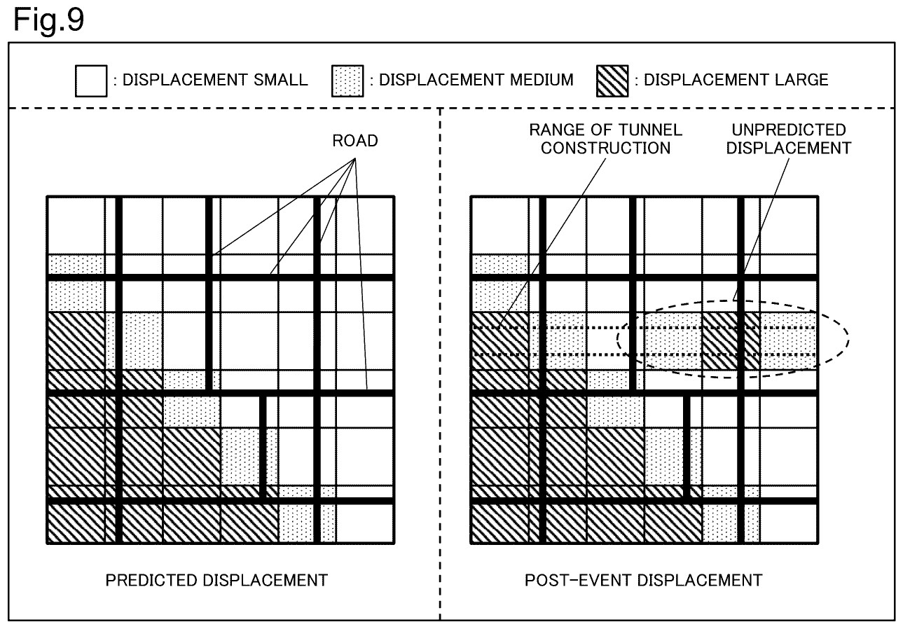

The determination based on the displacement will be described with reference to the drawings. FIG. 9 is a diagram illustrating the determination based on the displacement. The left side of FIG. 9 is the predicted displacement. The right side of FIG. 9 is the post-event displacement. When the displacements illustrated on the left and right sides of FIG. 9 are compared, the post-event displacement in a range surrounded by a broken line in an upper portion of the post-event displacement on the right side of FIG. 9 is an unpredicted displacement and is the range of the tunnel construction. Therefore, impact determination unit 183 determines that the displacement in this range is impacted by the tunnel construction. The classification of the displacements is not limited to “large, medium, and small” illustrated in FIG. 9 and may be performed using any scale. For example, the displacements may be classified in increments of 1 mm.

A repair work of the road where a crack and the like occur, but sinking does not occur is a repair work of a surface layer such as an asphalt layer. On the other hand, a repair work of the road where a crack does not occur, but sinking occurs is a repair work of a deep layer such as a road bed or a subgrade. Alternatively, there is a possibility that subsidence or the like will occur in the near future in the road where deterioration, such as a crack, does not occur in the surface, but sinking is progressing faster than predicted. Therefore, the user may close off the portion in advance or perform a repair work of the portion in advance. As described above, in a case where a change in any one of the surface layer state and the displacement is large, measures, such as repair works related to the portion, may be different. That is, the information of the position or range where it is determined that one of the surface layer state and the displacement has been impacted by the event is useful for the user.

Therefore, the impact determination unit 183 may output the position or range where it is determined that a change in any one of the surface layer state and the displacement is large. For example, the impact determination unit 183 may output the range in which the difference between the predicted crack rate and the post-construction crack rate is large and the difference between the predicted displacement and the post-event displacement is small. For example, the impact determination unit 183 may output the range in which the difference between the predicted crack rate and the post-construction crack rate is large and the difference between the predicted displacement and the post-event displacement is small.

### (2-4) Impact Determination System 13

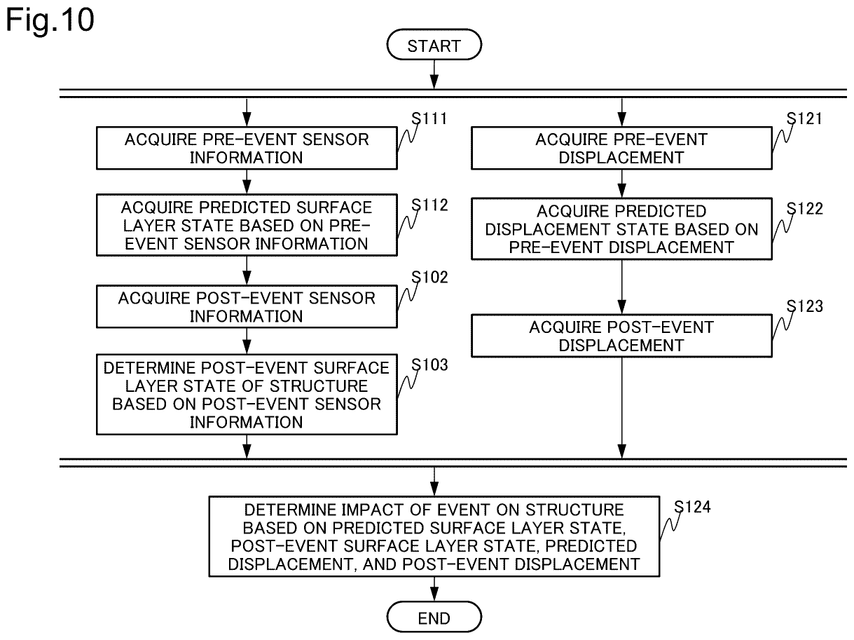

FIG. 10 is a flowchart illustrating an example of the operation of the impact determination system 13 according to the third example embodiment. The sensor information acquisition unit 120 acquires the pre-event sensor information (step S111). Then, the sensor information acquisition unit 120 stores the pre-event sensor information in the sensor information storage unit 125. The predicted state acquisition unit 110 acquires the predicted surface layer state based on the pre-event sensor information (step S112). The sensor information acquisition unit 120 further acquires the post-event sensor information (step S102). The state determination unit 130 determines the post-event surface layer state of the structure based on the post-event sensor information (step S103). The displacement acquisition unit 160 acquires the pre-event displacement (step S121). Then, the displacement acquisition unit 160 stores the pre-event displacement in the displacement storage unit 165. The predicted displacement acquisition unit 150 acquires the predicted displacement based on the pre-event displacement (step S122). The displacement acquisition unit 160 acquires the post-event displacement (step S123). The impact determination unit 183 determines the impact of the event on the structure based on the predicted surface layer state, the post-event surface layer state, the predicted displacement, and the post-event displacement (step S124). Either the operation in steps S211 to S103 or the operation in steps S121 to S123 may be executed first. Similarly to the impact determination system 12, the impact determination system 13 may repeat the operation every time a predetermined condition is satisfied.

In a case where the sensor information measurement device 20 is a dashboard camera (dashcam) mounted on a vehicle, the sensor information is an image of a road on which the vehicle can travel. That is, the surface layer state is the state of the road. On the other hand, in a case where the ground surface observation system 30 uses an SAR mounted on an artificial satellite, the displacement is a displacement that also includes a portion other than the road. As described above, in general, the range of the displacement is wider than the range of the surface layer state.

For example, in the case of tunnel construction under the road, the impact of the tunnel construction may spread to the periphery of the road in addition to the road above the tunnel construction. However, the dashcam is not capable of measuring the sensor information in a range other than the road. Therefore, for example, the impact determination system 13 can more accurately determine the impact of the tunnel construction on the road, using the displacement around the road in addition to the surface layer state and displacement of the road above the tunnel construction.

The sensor information measurement device 20 measures sensor information in a range in which the moving object having the sensor information measurement device 20 mounted thereon can move. For example, in a case where the sensor information measurement device 20 is a dashcam mounted on a vehicle, the sensor information is an image of the road on which the vehicle can travel. That is, the surface layer state is the state of the road. On the other hand, in a case where the ground surface observation system 30 uses an SAR mounted on an artificial satellite, in general, the displacement is a displacement that also includes a portion other than the road. As described above, in general, the range of the displacement is wider than the range of the surface layer state.

For example, in the case of tunnel construction under the road, the impact of the tunnel construction may spread to the periphery of the road in addition to the road above the tunnel construction. However, the dashcam is not capable of measuring the sensor information in a range other than the road. On the other hand, the SAR can observe a region around the road. Therefore, for example, the impact determination system 13 can more accurately determine the impact of the tunnel construction on the road, using the displacement around the road in addition to the surface layer state and displacement of the road above the tunnel construction. As a result, the impact determination system 13 can more appropriately determine the impact of the event.

In general, the spatial resolution of the displacement is in a wide range to some extent. For example, in many cases, the spatial resolution of the SAR is a few meters at most. On the other hand, the spatial resolution of the surface layer state determined using the sensor information is about several centimeters to several tens of centimeters. The spatial resolution of the surface layer state is the minimum distance between two surface layer states determined using the sensor information. Then, the impact determination system 13 determines the impact of the event based on the displacement and the surface layer state. Therefore, the impact determination system 13 can implement determination with higher spatial resolution than the displacement.

In general, in many cases, the observation cycle on which the displacement is analyzed is longer than the measurement cycle of the sensor information used to determine the surface layer state. That is, in many cases, the measurement time of the sensor information used for the determination is closer to the observation time used to determine the displacement on average. Therefore, the impact determination system 13 can implement the determination using information temporally closer than the displacement on average, using the surface layer state. As described above, the displacement and the surface layer state have different advantages. Therefore, the impact determination system 13 implements more appropriate determination of the impact of the event, using both the displacement and the surface layer state.

The displacement used by the impact determination system 13 is, for example, the sinking or upheaval of the structure. For example, in a case where the structure is a road, the impact determination system 13 uses the sinking or upheaval of the road as the displacement. However, the displacement used by the impact determination system 13 is not limited to the displacement in the vertical direction with respect to the ground, such as sinking and upheaval, but the impact determination system 13 may use a displacement including a component in the horizontal direction.

Similarly to the impact determination systems 11 and 12, the impact determination system 13 may use a speed that is a rate of change in the surface layer state or acceleration that is a rate of change in the speed of the surface layer state in addition to or instead of the surface layer state. The impact determination system 13 may use at least one of a speed that is a rate of change in the displacement and acceleration that is a rate of change of the speed of the displacement in addition to or instead of the displacement. For example, in a case where the displacement of a certain point increases with the lapse of time, the speed of a change in the displacement is a speed at which the magnitude of the displacement changes. The speed of the displacement and the acceleration of the displacement can be calculated based on the accumulated data.

### (3) Display Device 40

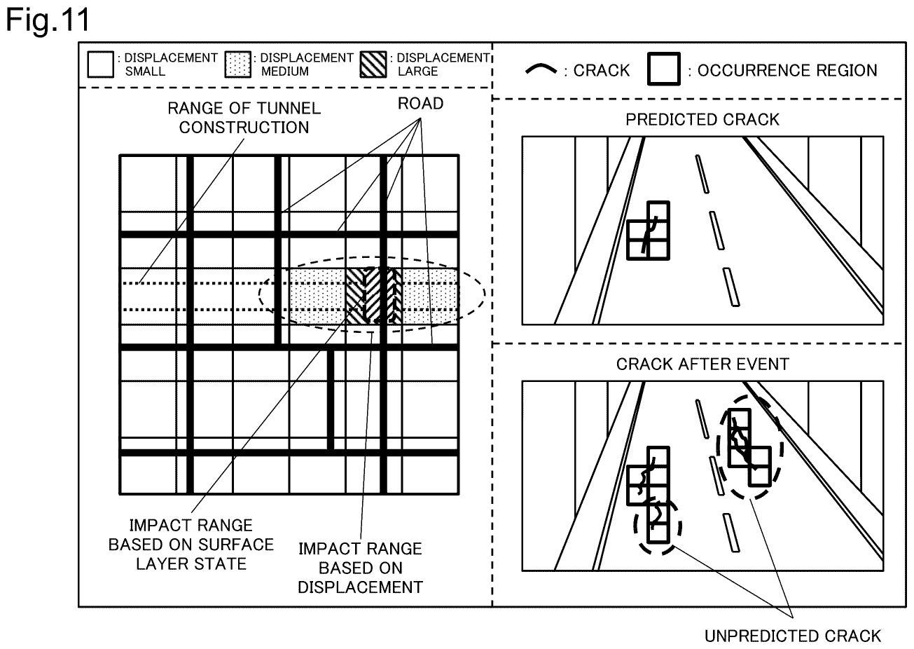

The display device 40 displays the determination result as in the second example embodiment. The display device 40 may display the displacement in addition to the determination result from the impact determination system 13. FIG. 11 is a diagram illustrating an example of display including the displacement. FIG. 11 illustrates a range impacted by the event determined based on the displacement in addition to the display of the range impacted by the event determined based on the surface layer state in FIG. 7.

### Hardware Configuration

Next, a hardware configuration of the impact determination systems 11, 12, and 13 will be described using the impact determination system 13. Each component of the impact determination system 13 may be configured by hardware circuits. Alternatively, in the impact determination system 13, each component may be configured using a plurality of devices that are connected via a network. For example, the impact determination system 13 may be configured using cloud computing. Alternatively, in the impact determination system 13, a plurality of components may be configured by one hardware component.

The impact determination system 13 may be implemented as a computer device including a central processing unit (CPU), a read only memory (ROM), and a random access memory (RAM). The impact determination system 13 may be implemented as a computer device including another configuration, such as a network interface card (NIC), in addition to the above-described configurations.

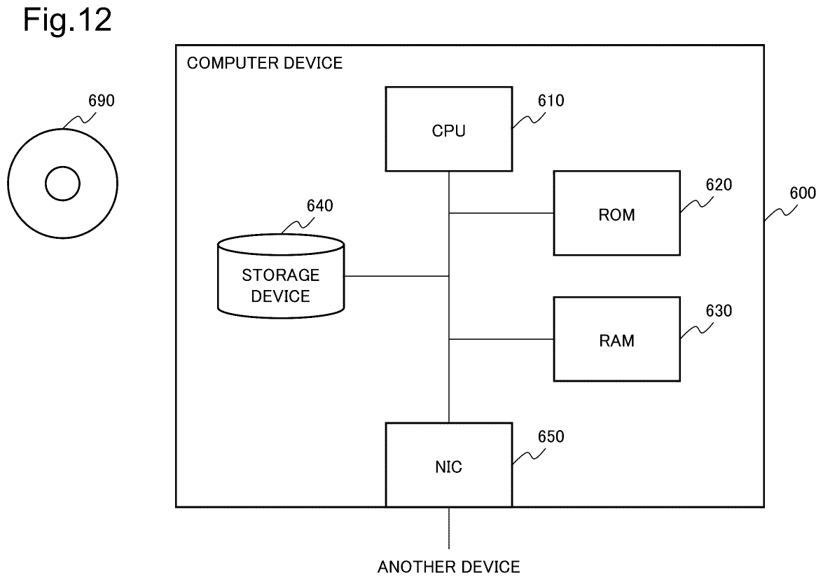

FIG. 12 is a block diagram illustrating an example of a hardware configuration of a computer device 600 constituting the impact determination system 13. The computer device 600 includes a CPU 610, a ROM 620, a RAM 630, a storage device 640, and an NIC 650. The CPU 610 reads a program from at least one of the ROM 620 and the storage device 640. Then, the CPU 610 controls the RAM 630, the storage device 640, and the NIC 650 based on the read program. Then, the computer device 600 including the CPU 610 controls these configurations to implement functions of the predicted state acquisition unit 110, the sensor information acquisition unit 120, the sensor information storage unit 125, the state determination unit 130, and the impact determination unit 183 of the impact determination system 13. The computer device 600 implements functions of the predicted displacement acquisition unit 150, the displacement acquisition unit 160, and the displacement storage unit 165.

When implementing each function, the CPU 610 may use at least one of the RAM 630 and the storage device 640 as a temporary storage medium for programs and data. The CPU 610 may read a program included in a recording medium 690 that stores computer-readable programs, using a recording medium reading device (not illustrated). Alternatively, the CPU 610 may acquire a program from another device (not illustrated) via the NIC 650, store the acquired program in at least one of the RAM 630 and the storage device 640, and operate based on the stored program.

The ROM 620 stores the programs executed by the CPU 610 and fixed data. The ROM 620 is, for example, a programmable ROM (P-ROM) or a flash ROM. The RAM 630 temporarily stores at least one of the program executed by the CPU 610 and data. The RAM 630 is, for example, a dynamic RAM (D-RAM). The storage device 640 stores the data and programs to be stored for a long time by the computer device 600. The storage device 640 implements the functions of the sensor information storage unit 125 and the displacement storage unit 165. The storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. Therefore, the CPU 610 can operate based on the program stored in at least one of the ROM 620, the storage device 640, and the RAM 630. That is, the CPU 610 can operate using at least one of the non-transitory recording medium and the transitory recording medium.

The NIC 650 relays exchange of data with another device (not illustrated) via the network. The NIC 650 is, for example, a local area network (LAN) card. The NIC 650 is not limited to the wired communication card and may be a wireless communication card. In the computer device 600 configured as described above, the CPU 610 implements the same functions as those of the impact determination system 11, 12, or 13 based on the program.

### Example of Usage of Impact Determination System

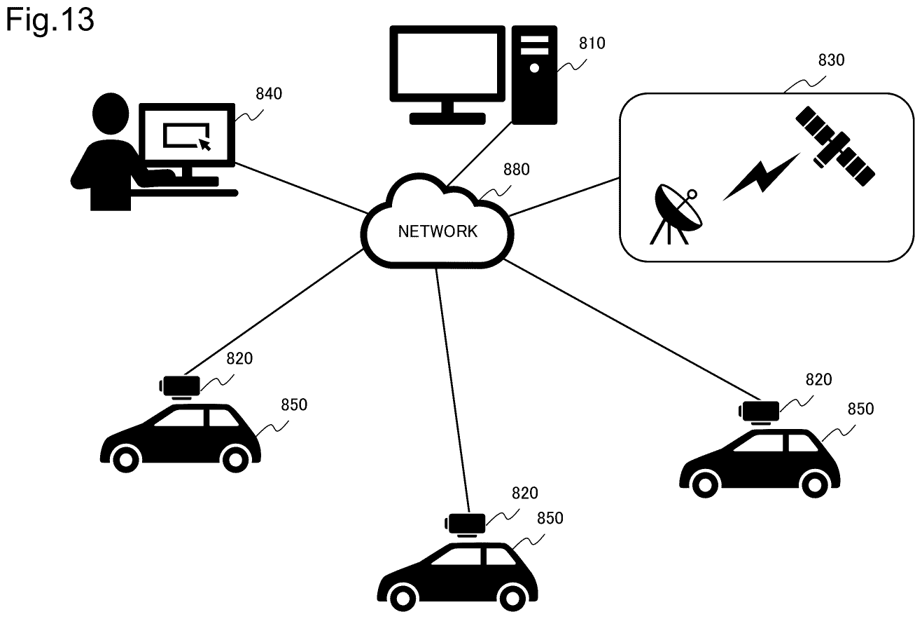

As a description of the impact determination system 13, a specific example of a system using the impact determination system 13 will be described with reference to the drawings. FIG. 13 is a conceptual diagram illustrating the entire system. In FIG. 13, the subjects of configurations may be the same or different. In FIG. 13, a computer device 810 is an example of the impact determination system 13. A dashcam 820 is an example of the sensor information measurement device 20. An SAR system 830 including an artificial satellite equipped with an SAR and a ground station is an example of the ground surface observation system 30. A terminal device 840 is an example of the display device 40. A vehicle 850 is an example of the moving object. In FIG. 13, the dashcam 820 is mounted outside the vehicle 850. However, the dashcam 820 may be mounted inside the vehicle 850.

A network 880 is a communication path that connects each device and each system. For example, the network 880 may be the Internet, a public telephone line, a dedicated communication network, or a combination thereof. However, the network 880 is not limited to the above and may be any communication path as long as it is a communication path capable of connecting each device and each system. The network 880 may be configured using a plurality of networks instead of one network. For example, the network 880 may be configured using different networks as the networks used for the following connections between the computer device 810 and other devices or systems.
Connection between Computer Device 810 and Dashcam 820
Connection between Computer Device 810 and SAR system 830
Connection between Computer Device 810 and Terminal device 840

Alternatively, in a case where a plurality of dashcams 820 are included, the network 880 may be configured using a plurality of networks associated to the positions of the dashcams 820 as the connections between the computer device 810 and the dashcams 820.

As described above, the number of configurations included in FIG. 13 is an example and is not limited to the number illustrated in FIG. 13. For example, the number of dashcams 820 is not limited to three and may be one, two, or four or more. The configurations illustrated in FIG. 13 can be replaced with other devices or systems. For example, the dashcam 820 may be mounted on a moving object, such as a drone, different from the vehicle 850. Alternatively, the dashcam 820 may be replaced with a fixed camera.

The vehicle 850 is equipped with the dashcam 820 and travels on a structure such as a road or a bridge. The vehicle 850 may travel in a structure such as a tunnel. The dashcam 820 measures the sensor information of the structure, such as a road or a bridge, on which the vehicle 850 travels and outputs the measured sensor information to the computer device 810. For example, the dashcam 820 measures an image and acceleration as the sensor information and outputs the sensor information to the computer device 810. The SAR system 830 outputs an observation result of a ground surface to the computer device 810. Alternatively, the SAR system 830 analyzes the observation result and outputs the displacement of the ground surface including the structure.

The computer device 810 acquires the pre-event sensor information from the dashcam 820 and stores the pre-event sensor information. Then, the computer device 810 acquires the predicted surface layer state based on the pre-event sensor information. The computer device 810 acquires the post-event sensor information from the dashcam 820. Then, the computer device 810 determines the post-event surface layer state based on the post-event sensor information. The computer device 810 acquires the observation result before the event from the SAR system 830, analyzes the acquired observation result to acquire the pre-event displacement, and stores the pre-event displacement. Alternatively, the computer device 810 acquires the pre-event displacement from the SAR system 830 and stores the pre-event displacement. That is, the computer device 810 stores the pre-event displacement that is the result of the analysis using the observation before the event in the SAR system 830. Then, the computer device acquires the predicted displacement based on the pre-event displacement. The computer device 810 acquires the post-event displacement from the SAR system 830. Then, the computer device 810 determines the impact of the event on the structure based on the predicted surface layer state, the post-event surface layer state, the predicted displacement, and the post-event displacement. Then, the computer device 810 outputs the determination result to the terminal device 840. The terminal device 840 displays the determination result acquired from the computer device 810.

Generally available products and systems can be applied as the computer device 810, the dashcam 820, the SAR system 830, the terminal device 840, and the vehicle 850. For example, a general personal computer may be used as the computer device 810. As described above, the devices and systems used as the computer device 810, the dashcam 820, the SAR system 830, the terminal device 840, and the vehicle 850 are not particularly limited.

Some or all of the above-described example embodiments may be described as the following supplementary notes, but are not limited to the following supplementary notes.

### Supplementary Note 1

An impact determination system including:
a predicted state acquisition means for acquiring a predicted surface layer state of a structure after an event, the predicted surface layer state being sensor information related to a surface of the structure on a ground surface and having been predicted based on pre-event sensor information measured before the event related to a ground of the structure;
a sensor information acquisition means for acquiring post-event sensor information measured after the event;
a state determination means for determining a post-event surface layer state of the structure based on the post-event sensor information; and
an impact determination means for determining an impact of the event on the structure based on the predicted surface layer state and the post-event surface layer state.

### Supplementary Note 2

The impact determination system according to Supplementary Note 1, wherein
the predicted state acquisition means acquires the predicted surface layer state based on the pre-event sensor information.

### Supplementary Note 3

The impact determination system according to Supplementary Note 1 or 2, wherein
the predicted state acquisition means acquires the predicted surface layer state at each of a plurality of time points after the event,
the sensor information acquisition means acquires the post-event sensor information at each of the plurality of time points after the event,
the state determination means determines the post-event surface layer state at each of the plurality of time points after the event based on the post-event sensor information at each of the plurality of time points after the event, and
the impact determination means determines the impact of the event based on the predicted surface layer state and the post-event surface layer state at each of the plurality of time points after the event.

### Supplementary Note 4

The impact determination system according to any one of Supplementary Notes 1 to 3, wherein
the sensor information acquisition means acquires the pre-event sensor information and the post-event sensor information at each of a plurality of positions,
the predicted state acquisition means acquires the predicted surface layer state at each of the plurality of positions,
the state determination means determines the post-event surface layer state at each of the plurality of positions, and
the impact determination means determines the impact of the event based on the predicted surface layer state and the post-event surface layer state at each of the plurality of positions.

### Supplementary Note 5

The impact determination system according to any one of Supplementary Notes 1 to 4, wherein
the sensor information acquisition means adds the acquired post-event sensor information to the pre-event sensor information, and
the predicted state acquisition means uses the pre-event sensor information to which the post-event sensor information has been added in the acquisition of the predicted surface layer state.

### Supplementary Note 6

The impact determination system according to any one of Supplementary Notes 1 to 5, further including:
a predicted displacement acquisition means for acquiring a predicted displacement of the structure after the event, the predicted displacement being a displacement of the structure and having been predicted based on a pre-event displacement acquired before the event; and
a displacement acquisition means for acquiring a post-event displacement of the structure based on an observation result acquired after the event, wherein
the impact determination means determines the impact of the event on the structure based on the predicted displacement and the post-event displacement.

### Supplementary Note 7

The impact determination system according to Supplementary Note 6, wherein
the predicted displacement acquisition means acquires the predicted displacement based on the pre-event displacement.

### Supplementary Note 8

The impact determination system according to any one of Supplementary Notes 1 to 7, wherein
the event is at least one of an underground construction of the structure, a construction around the structure, a ground construction, an accident, and a disaster.

### Supplementary Note 9

The impact determination system according to any one of Supplementary Notes 1 to 8, wherein
the impact determination means determines the impact of the event further based on at least one of a geological layer of the ground of the structure, a range in which the event has occurred, a topography around the structure, a geology, soil, weather, a construction type, and a construction method.

### Supplementary Note 10

The impact determination system according to any one of Supplementary Notes 1 to 9, wherein
the sensor information acquisition means acquires the post-event sensor information from a sensor information measurement device mounted on a moving object.

### Supplementary Note 11

The impact determination system according to Supplementary Note 10, wherein
the moving object is a vehicle,
the sensor information measurement device is a dashboard camera, and
the sensor information is an image of the surface of the structure.

### Supplementary Note 12

The impact determination system according to Supplementary Note 6 or 7, wherein
the displacement acquisition means acquires the post-event displacement based on an observation result of a ground surface observation system including a synthetic aperture radar that observes the ground surface including the structure.

### Supplementary Note 13

An impact determination method including:
acquiring a predicted surface layer state of a structure after an event, the predicted surface layer state being sensor information related to a surface of the structure on a ground surface and having been predicted based on pre-event sensor information measured before the event related to a ground of the structure;
acquiring post-event sensor information measured after the event;
determining a post-event surface layer state of the structure based on the post-event sensor information; and
determining an impact of the event on the structure based on the predicted surface layer state and the post-event surface layer state.

### Supplementary Note 14

A recording medium having recorded thereon a program causing a computer to execute:
a process of acquiring a predicted surface layer state of a structure after an event, the predicted surface layer state being sensor information related to a surface of the structure on a ground surface and having been predicted based on pre-event sensor information measured before the event related to a ground of the structure;
a process of acquiring post-event sensor information measured after the event;
a process of determining a post-event surface layer state of the structure based on the post-event sensor information; and
a process of determining an impact of the event on the structure based on the predicted surface layer state and the post-event surface layer state.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

11 impact determination system
12 impact determination system
13 impact determination system
20 sensor information measurement device
30 ground surface observation system
40 display device
110 predicted state acquisition unit
120 sensor information acquisition unit
125 sensor information storage unit
130 state determination unit
150 predicted displacement acquisition unit
160 displacement acquisition unit
165 displacement storage unit
180 impact determination unit
183 impact determination unit
600 computer device
610 CPU
620 ROM
630 RAM
640 storage device
650 NIC
810 computer device
820 dashboard camera
830 SAR system
840 terminal device
850 vehicle
880 network

What is claimed is:

1. An impact determination system comprising:
a memory configured to store instructions; and
one or more processors configured to execute the instructions to:
acquire a predicted surface layer state of a structure after an event, the predicted surface layer state being sensor information related to a surface of the structure on a ground surface and having been predicted based on pre-event sensor information measured before the event related to a ground of the structure;
acquire post-event sensor information measured after the event;
determine a post-event surface layer state of the structure based on the post-event sensor information; and
determine an impact of the event on the structure based on the predicted surface layer state and the post-event surface layer state.

2. The impact determination system according to claim 1, wherein
the one or more processors are further configured to execute the instructions to:
acquire the predicted surface layer state based on the pre-event sensor information.

3. The impact determination system according to claim 1, wherein
the one or more processors are further configured to execute the instructions to:
acquire the predicted surface layer state at each of a plurality of time points after the event;
acquire the post-event sensor information at each of the plurality of time points after the event;
determine the post-event surface layer state at each of the plurality of time points after the event based on the post-event sensor information at each of the plurality of time points after the event; and
determine the impact of the event based on the predicted surface layer state and the post-event surface layer state at each of the plurality of time points after the event.

4. The impact determination system according to claim 1, wherein
the one or more processors are further configured to execute the instructions to:
acquire the pre-event sensor information and the post-event sensor information at each of a plurality of positions;
acquire the predicted surface layer state at each of the plurality of positions;
determine the post-event surface layer state at each of the plurality of positions; and
determine the impact of the event based on the predicted surface layer state and the post-event surface layer state at each of the plurality of positions.

5. The impact determination system according to claim 1, wherein
the one or more processors are further configured to execute the instructions to:
add the acquired post-event sensor information to the pre-event sensor information; and
use the pre-event sensor information to which the post-event sensor information has been added in a next acquisition of the predicted surface layer state.

6. The impact determination system according to claim 1, wherein
the one or more processors are further configured to execute the instructions to:
acquire a predicted displacement of the structure after the event, the predicted displacement being a displacement of the structure and having been predicted based on a pre-event displacement acquired before the event;
acquire a post-event displacement of the structure based on an observation result observed after the event; and
determine the impact of the event on the structure based on the predicted displacement and the post-event displacement.

7. The impact determination system according to claim 6, wherein
the one or more processors are further configured to execute the instructions to:
acquire the predicted displacement based on the pre-event displacement.

8. The impact determination system according to claim 1, wherein
the event is at least one of an underground construction of the structure, a construction around the structure, a ground construction, an accident, and a disaster.

9. The impact determination system according to claim 1, wherein
the one or more processors are further configured to execute the instructions to:
determine the impact of the event further based on at least one of a geological layer of the ground of the structure, a range in which the event has occurred, a topography around the structure, a geology, soil, weather, a construction type, and a construction method.

10. The impact determination system according to claim 1, wherein
the one or more processors are further configured to execute the instructions to:
acquire the post-event sensor information from a sensor information measurement device mounted on a moving object.

11. The impact determination system according to claim 10, wherein
the moving object is a vehicle,
the sensor information measurement device is a dashboard camera, and
the sensor information is an image of the surface of the structure.

12. The impact determination system according to claim 6, wherein
the one or more processors are further configured to execute the instructions to:
acquire the post-event displacement based on an observation result of a ground surface observation system including a synthetic aperture radar that observes the ground surface including the structure.

13. An impact determination method comprising:
acquiring a predicted surface layer state of a structure after an event, the predicted surface layer state being sensor information related to a surface of the structure on a ground surface and having been predicted based on pre-event sensor information measured before the event related to a ground of the structure;
acquiring post-event sensor information measured after the event;
determining a post-event surface layer state of the structure based on the post-event sensor information; and
determining an impact of the event on the structure based on the predicted surface layer state and the post-event surface layer state.

14. A non-transitory computer-readable recording medium having recorded thereon a program causing a computer to execute:
acquiring a predicted surface layer state of a structure after an event, the predicted surface layer state being sensor information related to a surface of the structure on a ground surface and having been predicted based on pre-event sensor information measured before the event related to a ground of the structure;
acquiring post-event sensor information measured after the event;
determining a post-event surface layer state of the structure based on the post-event sensor information; and
determining an impact of the event on the structure based on the predicted surface layer state and the post-event surface layer state.
